(19) United States
(12) Patent Application Publication
(10) Pub. No.: US 2025/0390690 A1
(43) Pub. Date: Dec. 25, 2025

(54) EXHIBITOR

(71) Applicant: VTCG S.R.L., Cittadella (Padova) (IT)

(72) Inventor: Giovanni BAGGIO, San Giorgio In Bosco (IT)

(21) Appl. No.: 18/879,536

(22) PCT Filed: Jun. 28, 2023
(86) PCT No.: PCT/IB2023/056698

§ 371 Date: Dec. 27, 2024

(30) Foreign Application Priority Data
Jul. 1, 2022 (IT) 102022000013933
Jun. 19, 2023 (IT) 102023000012516

(51) Int. Cl. G06K 7/10; A47F 5/00

(52) U.S. Cl. CPC G06K 7/10366; A47F 5/0043

(57) ABSTRACT

An exhibitor for articles for selection and/or sale, which has a frame and one or more shelves associated with the frame

The exhibitor includes elements for automatic detection of the presence/absence of one or more of the articles for selection and/or sale.

### CROSS-REFERENCE TO RELATED APPLICATIONS

This application is a 35 U.S.C. § 371 National Stage patent application of PCT/IB2023/056698, filed on 28 Jun. 2023, which claims the benefit of Italian patent application 102022000013933, filed on 1 Jul. 2022, and Italian patent application 102023000012516, filed on 19 Jun. 2023, the disclosures of which are incorporated herein by reference in their entirety.

### TECHNICAL FIELD

The present disclosure relates to an exhibitor.

### BACKGROUND

Nowadays, to display articles, in particular in shops, shelving units or exhibitors are commonly used.

Usually exhibitors are constituted by a plurality of parallel shelves, fixed to a vertical supporting frame.

To purchase an article, the customer enters the shop, identifies the article of interest and, after taking it from the exhibitor, buys it.

Such known art has a number of drawbacks.

In fact, in order to be able to stock the exhibitor and understand what type of article needs to be restocked, it is necessary for a member of staff to physically visit the exhibitor to check the remaining articles and if necessary return with restocks of these.

This results in a restocking operation that is lengthy and inconvenient.

Furthermore, in order to also be able to verify the appeal of the articles offered for sale, and therefore their success with the consumer public, it is necessary to check:
either the goods missing from the exhibitors,
or the accounting records for the sales.

This too results in verification operations that are lengthy and bothersome.

Also, if it is necessary to change the price of the article on display, it is necessary for the operator to physically visit the exhibitor in order to change or replace the price tag, which is generally fixed to the corresponding shelf, with consequent operations that are lengthy and bothersome.

### SUMMARY

The aim of the present disclosure is to provide an exhibitor that is capable of improving the known art in one or more of the above mentioned aspects.

Within this aim, the disclosure provides an exhibitor that enables an immediate and automatic verification of the goods to be restocked and without the need for in-person verification by a member of staff.

The disclosure also devises an exhibitor that enables an immediate and automatic verification of the appeal of the goods to the consumer public and without the need for in-person verification of the exhibitor or of the sales records.

The disclosure further provides an exhibitor that makes it possible to change the price of the articles on display remotely and without the need for a person to physically execute the operation on the exhibitor.

Another feature of the present disclosure is to overcome the drawbacks of the known art in a different manner to any existing solutions.

Another feature of the disclosure is to provide an exhibitor that is highly reliable, easy to implement and of low cost.

This aim and these and other advantages which will become better apparent hereinafter are achieved by providing an exhibitor for articles for selection and/or sale, which comprises a frame and one or more shelves associated with said frame, said exhibitor being characterized in that it comprises means for automatic detection of the presence/absence of one or more of said articles for selection and/or sale.

### BRIEF DESCRIPTION OF THE DRAWINGS

Further characteristics and advantages of the disclosure will become more apparent from the description of some preferred, but not exclusive, embodiments of an exhibitor according to the disclosure, which are illustrated for the purposes of non-limiting example in the accompanying drawings wherein:

FIG. 1 is an overall perspective view of an exhibitor, according to the disclosure, in a first embodiment, in a configuration for use;

FIG. 2 is an overall perspective view of the exhibitor of FIG. 1, without articles on display;

FIG. 3 is a diagram of a component of the exhibitor of FIGS. 1 and 2;

FIGS. 4a and 4b show articles that can be displayed in an exhibitor according to the disclosure;

FIG. 5 is an overall perspective view of an exhibitor, according to the disclosure, in a second embodiment, in a configuration for use;

FIG. 6a is an overall perspective view of the exhibitor of FIG. 5, without articles on display;

FIG. 6b is an overall perspective view of an exhibitor, according to the disclosure, in a different embodiment; and

FIG. 7 is a diagram of a component of the exhibitor of FIGS. 5-6b.

### DETAILED DESCRIPTION OF THE DRAWINGS

With reference to the figures, an exhibitor, according to the disclosure, in a first embodiment, is generally designated by the reference numeral 10.

The exhibitor 10 comprises a frame 11 with a vertical configuration for use, which is provided with at least one shoulder 12, and one or more shelves 13 associated with the frame 11 and fixed to the shoulder 12.

Preferably, the frame 11 and the shelves 13 are made of metal.

In the exhibitor 10 a plurality of articles 14 for selection and/or sale can be displayed.

One of the peculiarities of the exhibitor 10 consists in that it comprises means 15 for automatic detection of the presence/absence of one or more articles 14.

Such means 15 for automatic detection comprise:
a central device 16 for reading one or more identification elements 17, each one of which is associated with an article 14,
a plurality of antennas 18a, 18b, 18c, 18d, 18e, 18f, 18g, . . . , 18n, connected to the central device 16.

Advantageously, the central device 16 is a UHF RFID reader (Radio Frequency Identification Ultra-High Frequency), for example of the type known by the trade name “URA8 Fixed Android RFID Reader” of the Shenzhen Chainway Information Technology Co., Ltd. company in Shenzhen, China.

In particular, this central device 16 is a fixed UHF RFID reader based on an Android operating system, with eight ports 19, integrated with the chip known by the trade name “RFID Impinj E710/R2000” of the Impinj Inc. company in Seattle, United States of America.

The central device 16 is powered by the mains electricity supply by way of a connection 20 and is connected to a user interface, not shown in the figures, such as a tablet computer and/or a smartphone and/or a PC (Personal Computer), over a data link as follows:
Wi-Fi 21,
and/or 4G LTE (Fourth Generation Long Term Evolution) 22,
and/or LAN (Local Area Network) 23,
and/or USB (Universal Serial Bus) 24,
and/or HDMI (High-Definition Multimedia Interface) 25.

In particular, the plurality of antennas 18a-18n comprises near field/short range and/or circular high-gain UHF RFID antennas.

Advantageously, such antennas 18a-18n are one or more of the ones known by the following trade names:
“A1130 Near Field/Short Range UHF RFID Antenna” of the Times-7 Research Ltd. company, of Petone, New Zealand,
“A1163 Near Field/Short Range UHF RFID Antenna” of the Times-7 Research Ltd. company, of Petone, New Zealand,
“A7030C Circular High Gain Antenna” of the Times-7 Research Ltd. company, of Petone, New Zealand,
“A5060C Circular High Gain Antenna” of the Times-7 Research Ltd. company, of Petone, New Zealand.

The identification elements 17 are UHF RFID labels/tags associated with/applied to the articles 14 or to their packaging.

Specifically, the antennas 18a-18n are associated with the shoulder 12 of the exhibitor 10, at one or more compartments 27 defined between two successive shelves 13 and/or with the underside 26 of one or more respective shelves 13.

In the present description, the term “underside” means the surface underneath a shelf 13, i.e. the surface of the shelf 13 directed toward the next shelf lower down.

It should be noted that the type of antennas 18a-18n and their distribution on the exhibitor 10 enables a three-dimensional reading of the identification elements 17 of the articles 14.

In the present description, the expression “three-dimensional reading” means that the UHF RFID tag 17 can be read, inside the compartment 27, placed in any position with respect to the antenna 18a-18n, as long as it is not screened.

It should also be noted that the use of antennas 18a-18n operating at radio frequencies in the UHF band enables a mass reading of elements in a restricted volume like that of a compartment 27.

Before being placed on the exhibitor 10, the articles 14 are labeled with adequate identification elements 17, which are adapted to be read by the central device 16.

Advantageously, such UHF RFID labels/tags constituting the identification elements 17 are one or more of those known with the following trade names:
“AD-229r6” of the Smartrac, Avery Dennison Corporation of Kedah, Malaysia, for articles 14 or packages made of paper-like material and/or plastic,
“AD-383u7” of the Smartrac, Avery Dennison Corporation of Kedah, Malaysia, for articles 14 or packages made of metallic material or metalized cardboard,
“AX'Label Classic” of the Axem Technology company of Créteil, France, for articles 14 or packages made of paper-like material and/or plastic,
“AX'Label Platina” of the Axem Technology company of Créteil, France, for articles 14 or packages made of metallic material or metalized cardboard.

Advantageously the identification elements 17 are arranged:
at a distance of at least a couple of centimeters from the shoulder 12, in order to allow the reading by the antennas 18a-18n,
at a distance of at least five centimeters from a corresponding high gain circular antenna,
at a distance such that they are not in mutual contact.

For example, the following can be arranged in the compartments 27:
a high gain circular antenna with a power of 9 dBm on the shoulder 12, and a high gain circular antenna with a power of 15 dBm on the underside 26 of the shelf 13 above;
and/or two near field/short range antennas with a power of 27 dBm on the shoulder 12, and a high gain circular antenna with a power of 15 dBm on the underside 26 of the shelf 13 above;
and/or a near field/short range antenna with a power of 30 dBm, on the shoulder 12.

The exhibitor 10 comprises a spacer, not shown in the figures, which is L-shaped in cross-section, for maintaining a distance of at least two centimeters between the articles 14 and the shoulder 12.

Specifically, such spacer has:
a core associated with the upper surface of the shelf 13, at/proximate to the shoulder 12,
a wing which is parallel to the shoulder 12.

In some other embodiments, the exhibitor comprises one or more auxiliary spacers 28, each one arranged between two successive articles 14, in order to avoid the overlapping of identification elements 17 and allow the reading thereof by the antennas 18a-18n.

The operation of the exhibitor 10 according to the disclosure is the following.

The central device 16 detects/reads, by way of the antennas 18a-18n, the identification elements 17, previously associated with respective articles 14 that are arranged on the shelves 13, and automatically communicates the data read, and the presence/absence of a given article 14 on display, to a user interface.

In this way it is possible to:
rapidly and automatically conduct stock-taking of the goods on display, and without the need for in-person verification,
rapidly and easily schedule the restocking of the articles 14 on display, and without the need for in-person verification,
verify the sales trend, and therefore the appeal to the consumer public, of a given article 14 automatically and without the need for in-person verification or the need to check sales records.

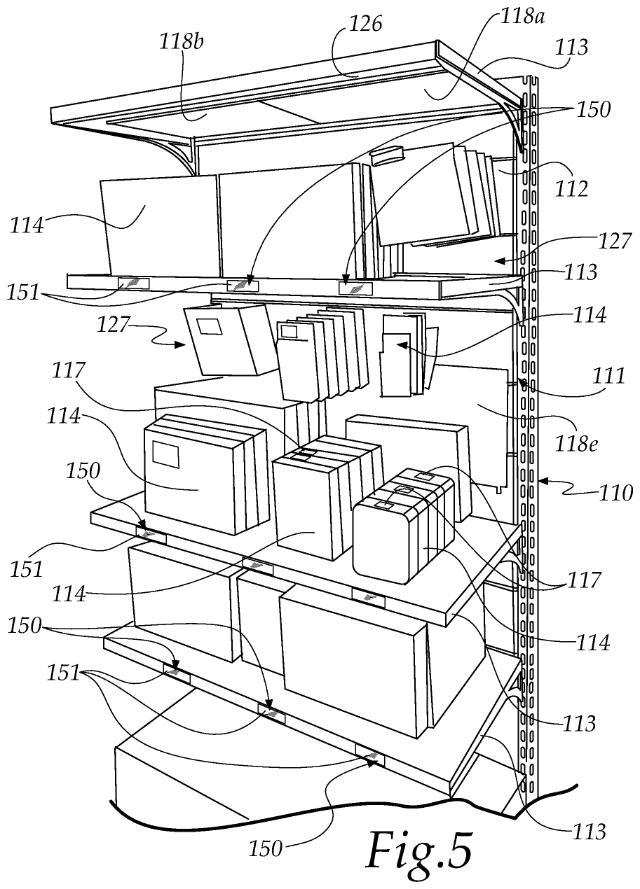

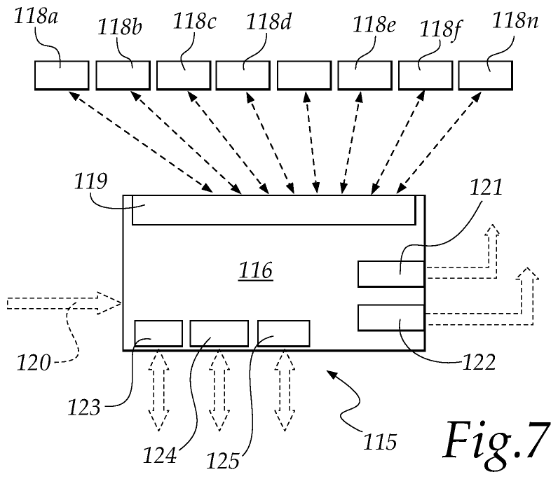

FIGS. 5 to 7 show different embodiments of the exhibitor according to the disclosure.

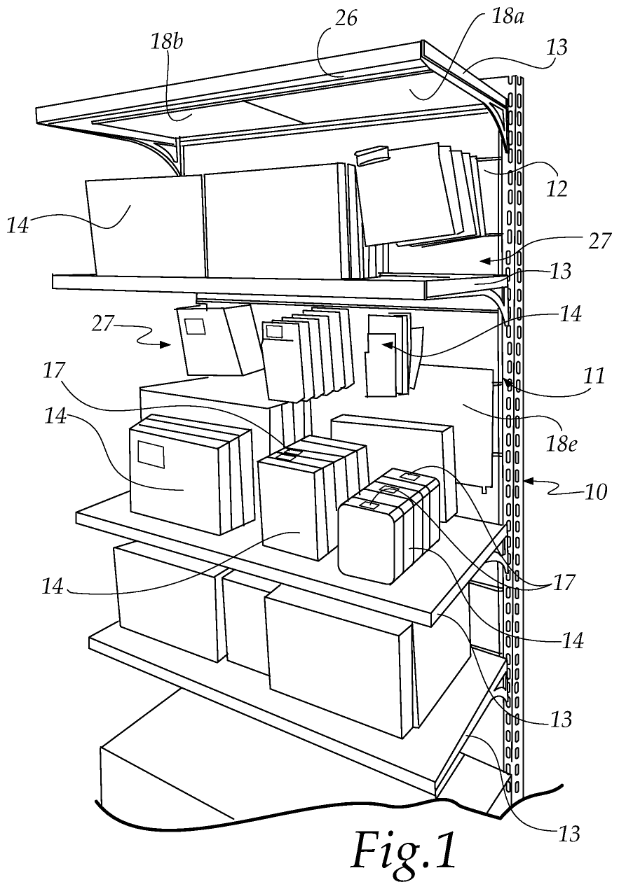

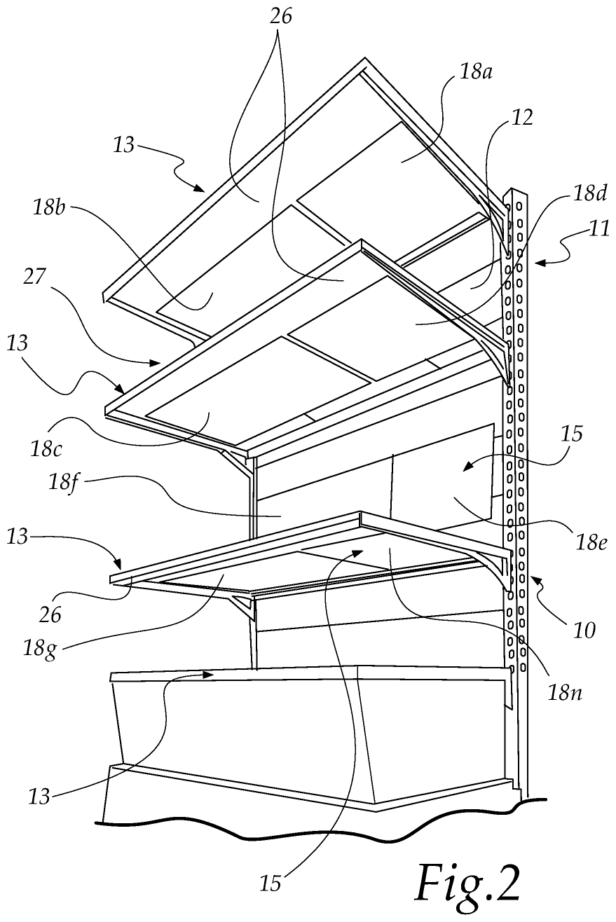

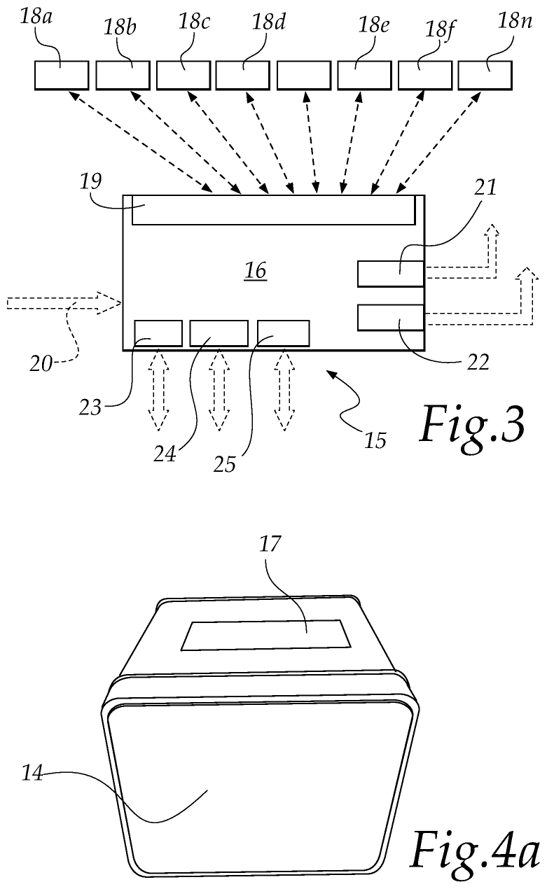

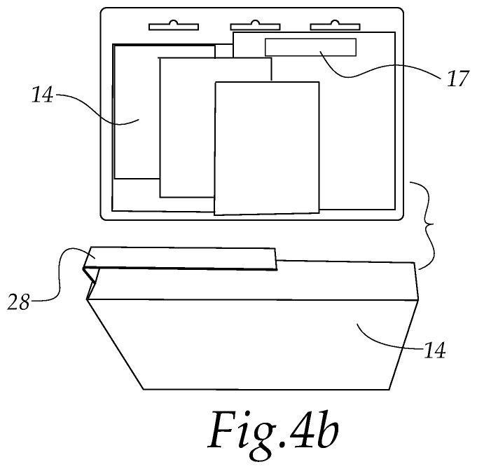

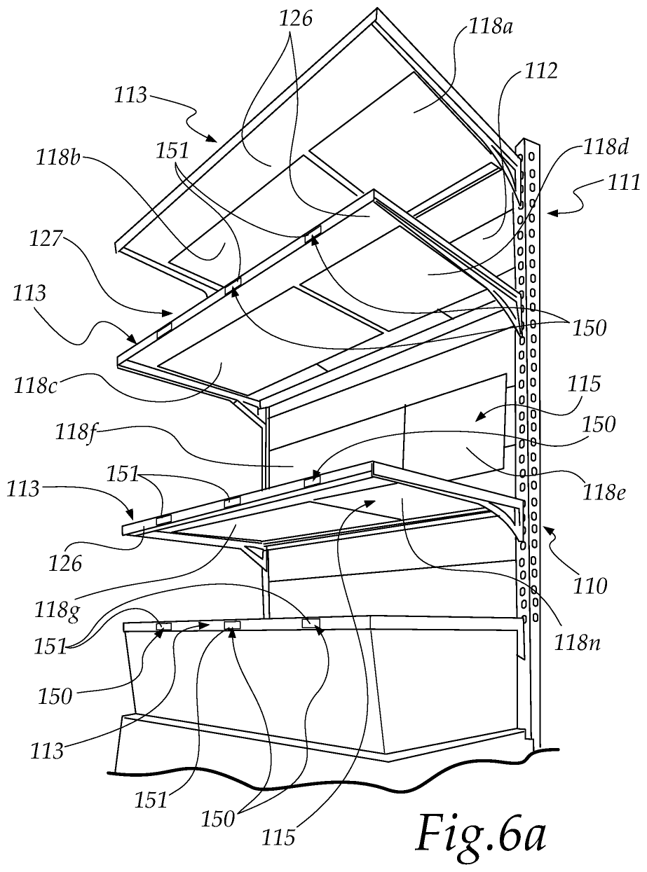

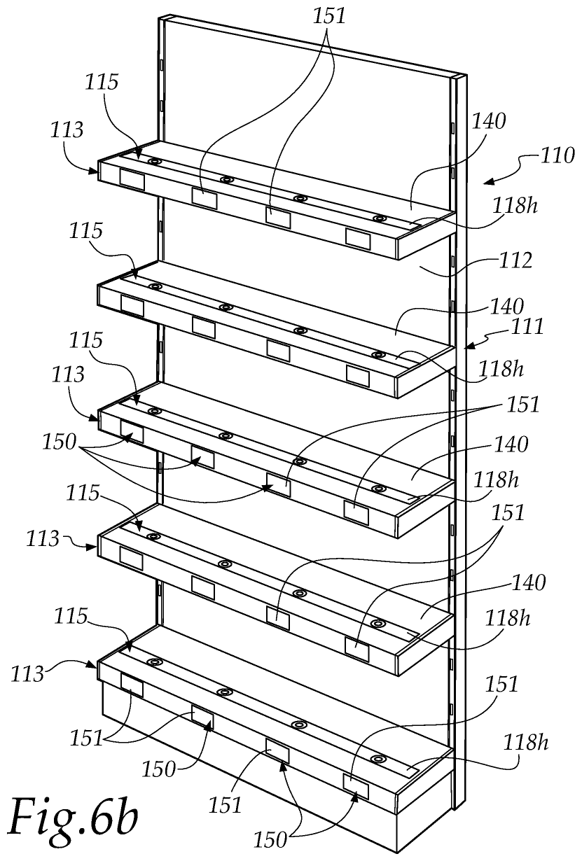

In FIGS. 5 to 6b, the elements of these embodiments that correspond to the same elements of the first embodiment (shown in FIGS. 1-4b) have been designated with the same number, increased by 100.

The exhibitor 110 is provided with means 150 for the remote modification of the prices of the articles 114.

Such means 150 for the remote modification of the prices of the articles 114 comprise:
one or more displays 151, each one fixed to a corresponding shelf 113 and arranged at a row of identical articles, in data communication with the central device 116,
such central device 116, in data communication with the user interface, as previously described.

In particular, the displays 151 are in data communication with the central device 116 by way of one or more antennas 118a-118n.

It should be noted that by virtue of the central device 116 which:
detects/reads, by way of the antennas 118a-118n, the identification elements 117, which were previously associated with respective articles 114,
and automatically communicates the data read to a user interface,

it is possible to change the price of the articles shown on the displays 151, directly and remotely, without the need to physically visit the exhibitor 110.

In practice it has been found that the disclosure fully achieves the intended aim and objects by providing an exhibitor that enables an immediate and automatic verification of the goods to be restocked and without the need for in-person verification by a member of staff.

It should be noted that with the disclosure an exhibitor has been devised that enables an immediate and automatic verification of the appeal of the goods to the consumer public and without the need for in-person verification of the exhibitor or of the sales records.

Furthermore, with the disclosure an exhibitor has been provided that makes it possible to change the price of the articles on display remotely and without the need for a person to physically execute the operation on the exhibitor.

The disclosure, thus conceived, is susceptible of numerous modifications and variations, all of which are within the scope of the appended claims. Moreover, all the details may be substituted by other, technically equivalent elements.

In practice the materials employed, provided they are compatible with the specific use, and the contingent dimensions and shapes, may be any according to requirements and to the state of the art.

1-17. (canceled)

18. An exhibitor for articles for selection and/or sale, the exhibitor comprising: a frame and one or more shelves associated with said frame, said exhibitor comprising detection means configured for automatic detection of presence/absence of one or more of said articles for selection and/or sale.

19. The exhibitor according to claim 18, wherein said frame has a vertical configuration for use and is provided with at least one shoulder, said one or more shelves being fixed to said shoulder.

20. The exhibitor according to claim 19, wherein said detection means configured for automatic detection comprise:
a central device for reading one or more identification elements, each one of which is associated with one of said articles, and
a plurality of antennas connected to said central device.

21. The exhibitor according to claim 20, wherein said central device is a UHF RFID reader.

22. The exhibitor according to claim 20, wherein said central device is of a type known by the trade name “URA8 Fixed Android RFID Reader” of the Shenzhen Chainway Information Technology Co., Ltd. company in Shenzhen, China.

23. The exhibitor according to claim 20, wherein said central device is a fixed UHF RFID reader based on an Android operating system, with eight ports, integrated with a chip known by the trade name “RFID Impinj E710/R2000” of the Impinj Inc. company in Seattle, United States of America.

24. The exhibitor according to claim 20, wherein said central device is powered by the mains electricity supply by a connection and is connected to a user interface over a data link as follows:
Wi-Fi,
and/or 4G LTE,
and/or LAN,
and/or USB,
and/or HDMI.

25. The exhibitor according to claim 20, wherein said plurality of antennas comprises UHF RFID antennas as follows:
near field/short range,
and/or circular high-gain.

26. The exhibitor according to claim 20, wherein said antennas are one or more of the ones known by the following trade names:
“A1130 Near Field/Short Range UHF RFID Antenna” of the Times-7 Research Ltd. company, of Petone, New Zealand,
“A1163 Near Field/Short Range UHF RFID Antenna” of the Times-7 Research Ltd. company, of Petone, New Zealand,
“A7030C Circular High Gain Antenna” of the Times-7 Research Ltd. company, of Petone, New Zealand, and
“A5060C Circular High Gain Antenna” of the Times-7 Research Ltd. company, of Petone, New Zealand.

27. The exhibitor according to claim 20, wherein said antennas are associated with said shoulder at one or more compartments defined between two successive shelves and/or with an underside of one or more respective shelves.

28. The exhibitor according to claim 20, further comprising one or more of said identification elements, said identification elements being UHF RFID labels/tags associated with/applied to said articles or packaging thereof.

29. The exhibitor according to claim 28, wherein said UHF RFID labels/tags are one or more of the ones known by the following trade names:
“AD-229r6” of the Smartrac, Avery Dennison Corporation of Kedah, Malaysia,
“AD-383u7” of the Smartrac, Avery Dennison Corporation of Kedah, Malaysia,
“AX'Label Classic” of the Axem Technology company of Créteil, France, and
“AX'Label Platina” of the Axem Technology company of Créteil, France.

30. The exhibitor according to claim 20, wherein said identification elements are arranged:
at a distance of at least a couple of centimeters from said shoulder,
at a distance of at least five centimeters from a corresponding high gain circular antenna, and
at a distance such that said identification elements are not in mutual contact.

31. The exhibitor according to claim 18, further comprising:
remote means configured for a remote modification of prices of said articles.

32. The exhibitor according to claim 31, wherein said remote means configured for the remote modification of the prices of said articles comprise:
one or more displays, each one fixed to a corresponding shelf and arranged at a row of identical said articles, said one or more displays being in data communication with said central device,
said central device, in data communication with a user interface.

33. The exhibitor according to claim 19, further comprising a spacer having an L-shaped cross-section, said spacer having:
a core associated with an upper surface of a respective one of said shelves, at/proximate to said shoulder, and
a wing which is parallel to said shoulder.

34. The exhibitor according to claim 18, further comprising one or more auxiliary spacers, each one of which is arranged between two successive said articles.
